(19) United States
(12) Patent Application Publication
(10) Pub. No.: US 2006/0034672 A1
(43) Pub. Date: Feb. 16, 2006

(54) Kit and method for producing a perfect bound book

(76) Inventors: Kristin Olson VanDeWalle, Bozeman, MT (US); Harold F. Metzger JR., Elmhurst, IL (US)

Correspondence Address: MCHALE & SLAVIN, P.A., 2855 PGA BLVD, PALM BEACH GARDENS, FL, 33410, US

(21) Appl. No.: 11/200,871

(22) Filed: Aug. 8, 2005

Related U.S. Application Data
(63) Continuation-in-part of application No. 10/323,271, filed on Dec. 18, 2002.

(51) Int. Cl. B42B 5/00

(52) U.S. Cl. 412/33

(57) ABSTRACT

A kit for constructing a perfect bound book comprises a cover having opposing cover panels and intervening first and second spine panels which panels are juxtaposed with interstitial spaces therebetween. The panels are adhered to flexible sheet material which provides flexible webbing in the interstitial spaces. The inside surface of the cover includes adhesive regions positioned on the first and second spine panels. Sheets of paper are provided which each have a binding edge and an adhesive region. The cover further comprises an alignment structure attached to and protruding from one of the spine panels, and the plurality of sheets of paper each include apertures therein sized to receive the alignment structure in a closely engaged arrangement. After assembly, the spine panels are in a fixed position and the cover panels are available to open along the flexible webbing. The images can be printed by a personal computer printer.

### CROSS REFERENCE TO RELATED APPLICATIONS

This application is a continuation-in-part of applicant's co-pending U.S. application Ser. No. 10/323,271, filed Dec. 18, 2002, the contents of which is hereby incorporated by reference.

### FIELD OF THE INVENTION

This invention relates generally to the field of book construction, and more particularly to a novel do-it-yourself kit for producing a perfect bound book.

### BACKGROUND OF THE INVENTION

The term “perfect bound book” is a widely-used term in the book manufacturing industry. A perfect bound book is constructed by gluing pages together, and then gluing the assembled pages to a spine form a book. (Perfect binding is an inexpensive alternative to sewn-together volumes.) Any book having individual pages glued together at the spine is considered a perfect bound book. This procedure is widely used in the book manufacturing industry as it is faster and less expensive than side or spine sewing, and it can be used to manufacture books which are too thick for saddle stitching. The perfect bound book has an appearance largely identical to a book with a sewn binding. An objective of the instant invention is to provide a do-it-yourself kit which produces a perfect bound book indistinguishable from a perfect bound volume mass-produced by a mechanical process (see, for example, U.S. Pat. No. 6,443,682 directed to an “Apparatus for Binding and Trimming a Perfect Bound Book.”)

In a fully mechanized process, folded signatures are used which are nested and then laid on top of one another. The folded edges must then be cut or ground off (producing individual sheets) so that the pages can be glued to one another. The stacked signatures are then glued into a cover. The kit of the instant invention provides a perfect bound book which is not produced by commercial book printers which utilize double-sided double-printed folded signatures, but rather uses individual sheets which can be printed by a standard home PC printer. Thus, what is proposed herein is a kit which allows one to produce a perfect bound book as a home craft project as an alternative to commercial prior art methods using folded signatures. A book produced by the instant invention is a perfect bound book according to well known industry criteria which would be recognized as such by anyone skilled in the art.

To consumers, the look and feel of a hardcover bound book lends import to the contents. Since computer software now makes it possible for an individual to create material which is comparable in appearance to that produced by a professional publishing house, it is highly desirable to provide a do-it-yourself means by which an individual can create a perfect bound book from their own material. Therefore, a need remains in the art for a kit for producing a perfect bound book which is especially adapted for digital images printed on a paper medium, and which enables a customer to use their own personal computer, printer and software to create a perfect bound book.

### DESCRIPTION OF THE PRIOR ART

Kraynak, et al., U.S. Pat. No. 3,892,427, discloses a method of preparing a personalized hard covered book which has variable and non-variable printed copy which utilizes a computer to print at least the personalized portions of the text. Continuous form computer printing sheets are pre-printed with the non-variable text of a given book. Variable text, such as a child's name and other personalized information, can be custom printed on the sheets containing non-variable text.

Ross, U.S. Pat. No. 5,465,213, discloses a computer based book manufacturing, distributing and retailing system for high speed reproduction of a single copy of a book. The system is intended for direct consumer sales since the manufacturing of a selected book can take place at the retail location. The system includes a computer having a database of books stored in digital formal. The system includes a binder for binding the text pages and cover into a book.

The present invention is directed to a do-it-yourself kit for producing a perfect bound book from the consumer's own material. In the prior art, patents disclosing “custom” bound books are directed only to the commercial manufacturing process of the perfect bound book.

### SUMMARY OF THE INVENTION

It is an objective of the invention to provide a self-contained do-it-yourself kit for producing a perfect bound book from digital images printed by a user on sheets of paper adapted for use in the kit. The digital images can be printed using a standard computer printer, such as an ink jet printer, or a color copier.

It is another objective to provide a self-contained do-it-yourself kit for producing a perfect bound book utilizes ink-jet paper for optimal image quality.

It is still another objective to provide a self-contained do-it-yourself kit for producing a perfect bound book which allows a user to utilize publishing software and digital image editing software on a personal computer to create custom pages for the book.

It is a further objective of the invention to provide a self-contained kit for producing a perfect bound book which can be sold as a single unit which includes the book-like cover portion and a supply of paper adapted for use in the kit.

It is a further objective of the invention to provide a self-contained kit for producing a perfect bound book which allows the user to select the desired number of pages for the album.

It is yet a further objective of the invention to provide a user with a novel method for assembling a perfect bound book from a user's own material.

It is a further objective of the invention to provide a self-contained kit for producing a perfect bound book which includes an integral page alignment tool.

In accordance with the above objectives, a do-it-yourself kit for constructing a perfect bound book is provided which comprises a book-like cover having an inside surface and an outside surface formed from first and second rigid cover panels and first and second rigid spine panels. The length of the spine panels is equal to that of the front and rear rigid cover panels and the width is substantially less that than that of the front and rear cover panels. The panels are juxtaposed along their respective lengths with interstitial spaces therebetween, with the spine panels interposed between the first and second rigid cover panels. The front and rear surfaces of the panels are coextensively adhered to a least one sheet flexible material with the flexible material providing flexible webbing in the interstitial spaces and the fabric forming the inside surface and outside surface of the cover. The inside surface of the cover including first and second adhesive regions, which can be in the form of double-sided tape, respectively positioned on the first and second spine panels.

A plurality of sheets of paper are provided which are sized to fit within the book-like cover with each of the sheets of paper having a binding edge and an adhesive region adjacent to the binding edge. Images can be printed on the sheets of paper by any suitable means, including a printer coupled to a personal computer, a color copier, or a digital printing press. The adhesive region can be double-sided tape. Each of the plurality of sheets of paper includes a score line adjacent the adhesive region. The plurality of sheets of paper can be adhered to one another in a substantially coextensive configuration by the adjoining the adhesive regions at the binding edge and then adhered to the cover by the first and second adhesive regions on the spine to form a perfect bound book. After assembly, the spine panels are placed in a fixed position and the cover panels are available to open along the interstitial spaces.

The cover further comprises an alignment structure attached to and protruding from one of the spine panels, and the plurality of sheets of paper each include at least one aperture therein sized to receive the alignment structure in a closely engaged arrangement with the alignment structure being positioned to properly align the paper within the cover. The alignment structure can comprise at least two cylindrical alignment pegs longitudinally aligned in the spine panel and extending perpendicularly therefrom, and the plurality of sheets of paper each include at least two apertures positioned in the adhesive region to align with the at least two alignment pegs. The alignment pegs can be integral to the spine panel, or selectably removable from the spine panel. In one embodiment, one of the spine panels includes holes therein sized to receive the at least two alignment pegs in a closely engaged arrangement.

The kit flexible material can include a first sheet of the flexible material covering the outer surface and a second sheet of flexible material covering the inner surface. The flexible material can be fabric, leather, or a petroleum-based synthetic sheeting material such as vinyl.

### BRIEF DESCRIPTION OF THE FIGURES

FIG. 1 illustrates the elements of the kit for producing a perfect bound book according to a preferred embodiment of the present invention, namely a book-like cover portion and a plurality of sheets of paper adapted for use in the kit of the invention;

FIG. 2 is a perspective view of the unassembled cover showing the alignment structure therein;

FIG. 3 illustrates the interior surfaces of the cover portion shown in FIG. 2 in an unassembled flat configuration;

FIG. 4 is a cross-section view of the cover construction taken along the line 4-4′ in FIG. 3;

FIG. 5 is a bottom end view of the cover portion shown in FIG. 2 in which the cover is shown in a folded configuration;

FIG. 6 illustrates the adhesive region on a sheet of paper according to the preferred embodiment of the invention;

FIGS. 7a-c illustrate the procedure for adhering the plurality of sheets of paper to one another; and

FIGS. 8a-f illustrate the steps of assembling the perfect bound book of the invention.

### DETAILED DESCRIPTION OF THE INVENTION

Although the invention will be described in terms of a specific embodiment, it will be readily apparent to those skilled in this art that various modifications, rearrangements, and substitutions can be made without departing from the spirit of the invention. The scope of the invention is defined by the claims appended hereto.

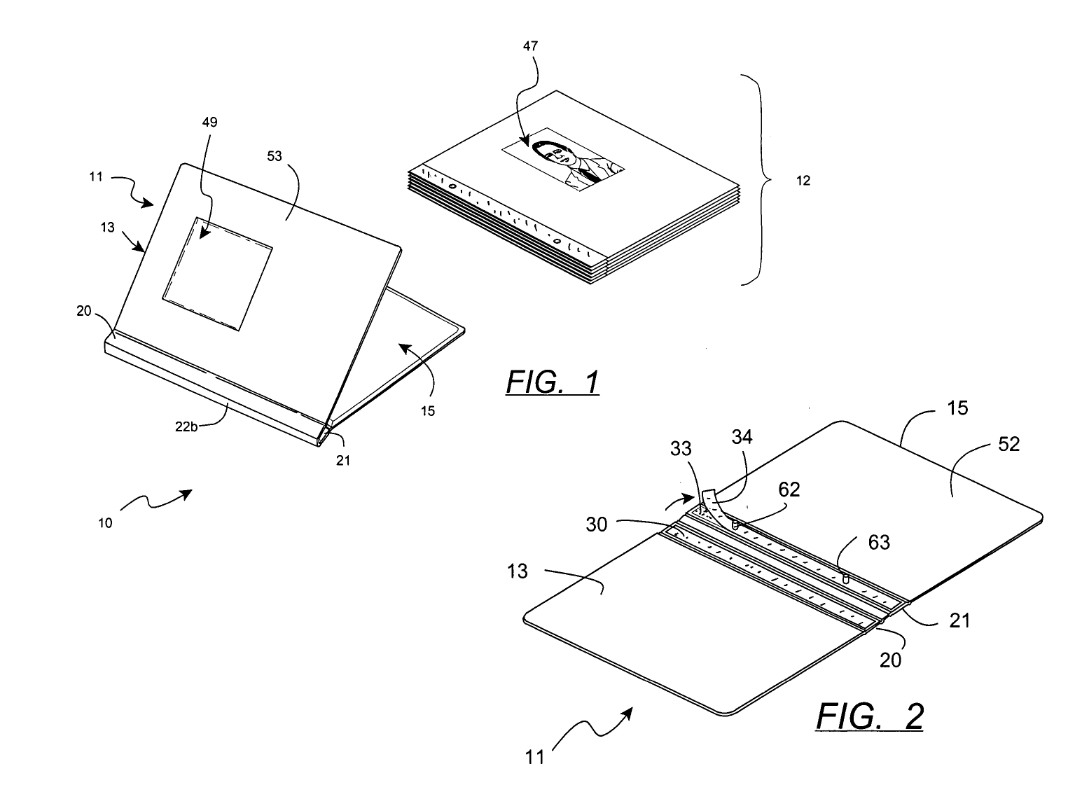

FIG. 1 illustrates the elements of the kit 10 of the invention. The kit 10 includes a rigid book-like cover 11 and a plurality of sheets of paper 12. The paper 12 is of a type of paper which can reproduce high quality photographic images from a digital source. Suitable types of paper would include ink jet printer paper or lightweight photographic paper. The paper 12 is sized to fit within the cover to create a perfect bound book. In the practice of the invention, images (as represented in the illustration by image 47) are printed onto the paper 12 using a printer coupled to a personal computer, a color copier, a digital printing press or any other suitable means to transfer digital images to the paper 12. The paper 12 includes an adhesive for assembling the perfect bound book, as will be discussed in detail hereinafter. Images can be printed on one or both sides of the paper.

FIGS. 2 and 3 illustrate the cover 11 in an unassembled configuration. The cover 11 has an inside surface 52 and an outside surface 53, and in an unassembled state can be extended to a flat configuration. The cover includes first and second rigid cover panels 13 and 15, and first and second rigid spine panels 20 and 21. Each of the panels 13, 15, 20 and 21 have equal length dimensions as defined by the length l. The width of the spine panels 21 and 20 is substantially less that than the widths of said front and rear cover panels. The kit 10 of the invention can have front and rear panels 13 and 15 sized to accommodate different paper sizes. In the construction of the cover 11 the panels are juxtaposed to align their respective lengths and positioned with the spine panels 20 and 21 interposed between the rigid cover panels 13 and 15 to define interstitial spaces 19a,b,c between the panels. The width of the interstitial space 19b is selected according to the desired thickness or page capacity of the book to the produced.

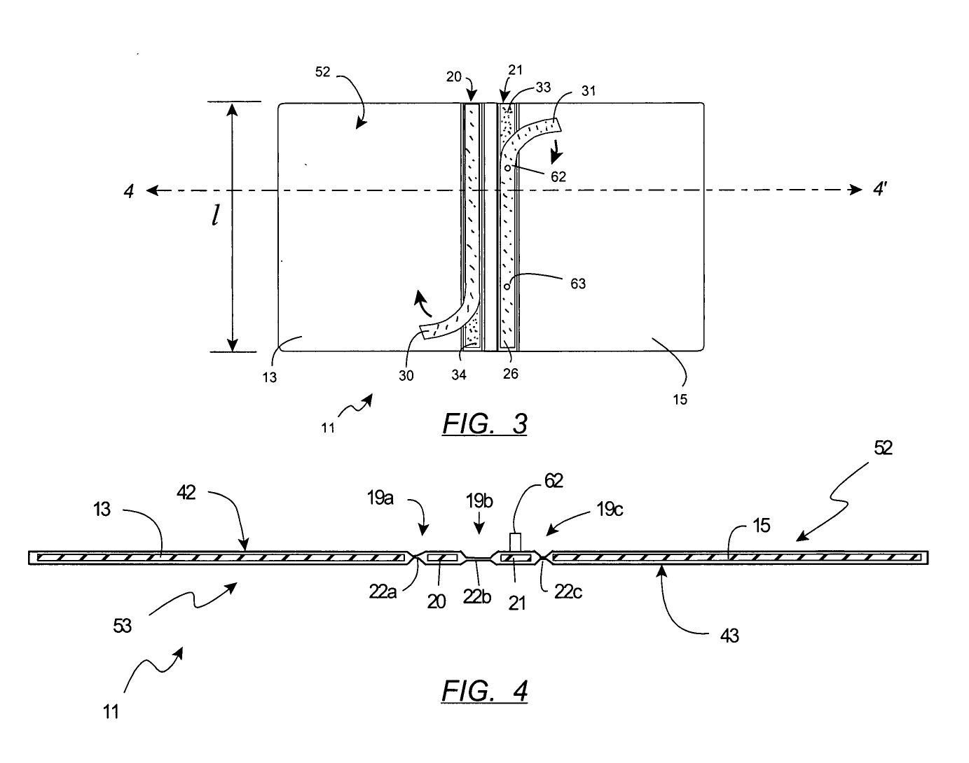

As can be seen in the cross-sectional view shown in FIG. 4, the front and rear surfaces of the panels are respectively coextensively adhered to a sheet of flexible material to construct the cover 11. The panels are fully encased in the flexible material. To construct the cover 11, either the same sheet adhered to both the front and rear surfaces, or a first sheet is adhered to the front surfaces and a second sheet to the rear surfaces. In the preferred embodiment shown in FIG. 4, a first sheet 42 of flexible material is adhered to the front surfaces of panels 13, 15, 20, and 21 as defined by outer surface 53 which will form the outside cover of the finished article. The first sheet 42 can be any desired material, such as fabric, leather, or synthetic petroleum-based materials such as vinyl. The material can be chosen to provide the desired esthetic appearance for the assembled book. The second sheet 43 is adhered to the rear surfaces of the panels and forms the interior liner of the assembled book. The first sheet 42 preferably overlaps the second sheet 43 somewhat on the rear surfaces so that the second sheet 43 is not visible when the assembled book is closed. The first sheet 42 defines an outside surface 52 and the second sheet 43 defines the inside surface 53 of the cover 11.

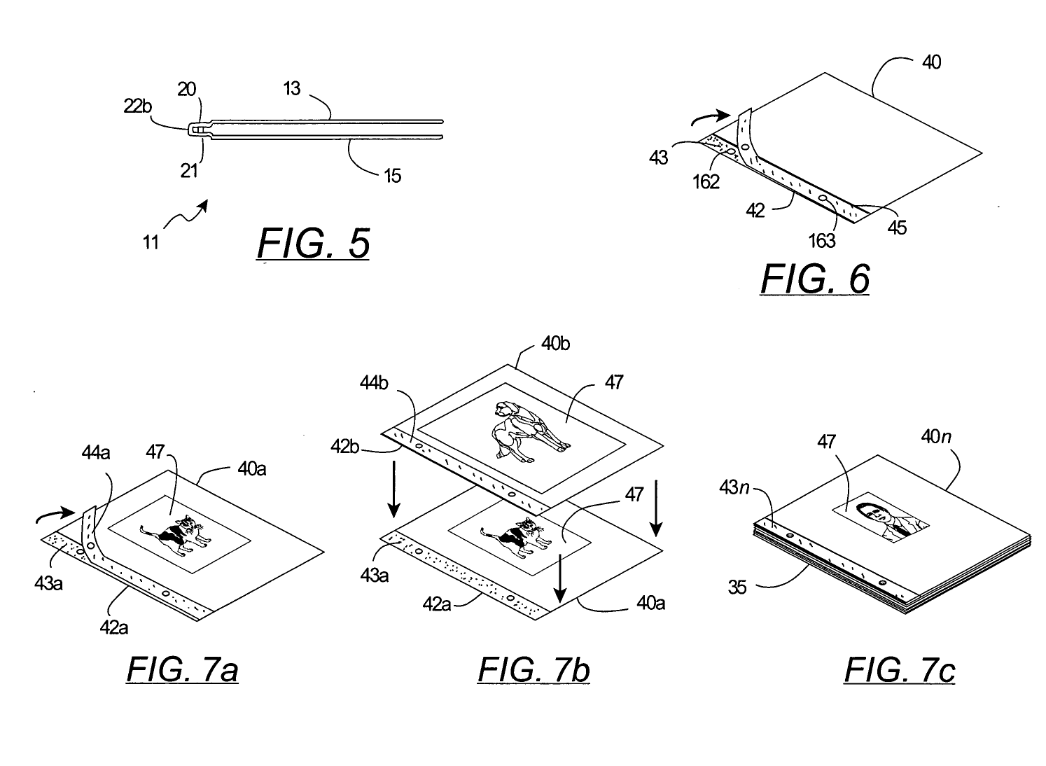

The first and second sheets 42 and 43 span the interstitial spaces 19a,b,c and provide a flexible webbing therein. The flexible webbings 22a,b,c shown in FIG. 2 function as articulating joints when the cover 11 is in an unassembled configuration. FIG. 5 shows the cover 11 in a closed configuration where it has been folded along flexible webbing 22b. After the book is assembled, the cover opens along flexible webbings 22a and 22c.

As shown in FIGS. 2 and 3, the inside surface 53 of the cover 11 includes first and second adhesive regions 33 and 34 respectively positioned on the first and second spine panels 20 and 21. The adhesive regions are initially covered with removable strips 30 and 31, shown partially peeled away in the figures. In a preferred embodiment, the adhesive regions are formed from a high tack double-sided tape, such as 415 tape manufactured by the Minnesota Mining and Manufacturing Company, St. Paul, Minn. A suitable adhesive can also be applied directly to the inside surface 53 in the form of an adhesive coating layer covered with a removable strip. The adhesive preferably has a cohesive strength which can provide a permanent bond to the paper 12.

FIG. 6 illustrates the construction of a single sheet of paper 40 as is used in the kit 10. Each sheet of paper 40 has an binding edge 42 which is defined as the edge which is adjacent to the spine panels 20 and 21 when the paper 12 is inserted into the cover 11. Each sheet of paper 40 includes adhesive region 43 in the form of an adhesive coating on one side which is adjacent to the inside edge 42. The adhesive region 43 is covered with a removable strip 44 prior to assembly. The adhesive region 43 can be an adhesive coating layer or double-sided tape as discussed above. In the practice of the invention, the removable strip 44 should be sufficiently adhered to the adhesive region 43 so as to stay intact when the sheet of paper 40 is fed through a printer or copier. Each sheet of paper 40 can include a score line 45 adjacent to the adhesive region 43. In the preferred embodiment, the paper 40 is ink jet paper or photographic paper, however the invention is not limited in this regard. Other types of paper can be utilized in the kit of the invention, such as art paper, simulated water color paper, canvas, or the like. As shown in Figs, images 47 can be printed on sheets 40, and the sheets adhered to one another using the adhesive regions 43 to form booklet bound at an edge 35.

In order to properly align the plurality of sheets of paper 12 with one another within the cover 11, the cover 11 can include an alignment structure which allows the paper 12 to be self-aligning. The alignment structure can be attached one of the spine panels 20,21 and is preferably configured to protrude perpendicularly the spine panel. Each of plurality of sheets of paper 12 includes at least one aperture sized to receive the alignment structure in a closely engaged arrangement. In the preferred embodiment shown in FIGS. 2 and 3, the alignment structure is cylindrical alignment pegs 62 and 63 which are longitudinally aligned in spine panel 21. In the illustrated embodiment, two alignment pegs 62 and 63 are shown, however any number of alignment pegs can be used. Referring again to FIG. 6, it can be seen that each of the plurality of sheets of paper each include apertures 162 and 163 which are positioned in the adhesive region 43 to align with the alignment pegs 62 and 63.

The alignment pegs 62 and 63 can be constructed in any suitable manner to provide the alignment structure. The pegs 62 and 63 formed as an integral part of one of either of the rigid spine panels 20,21 so that they extend through the second sheet of flexible material 43, or alternatively can be adhered to the flexible material 43. In the illustrated embodiment, the height of the pegs 62 and 63 is approximately equal to the width of the interstitial space 19b between the spine panels 20 and 21. Thus, when the kit 10 is assembled, the resulting book has thickness approximately equal to that of pegs 62 and 63.

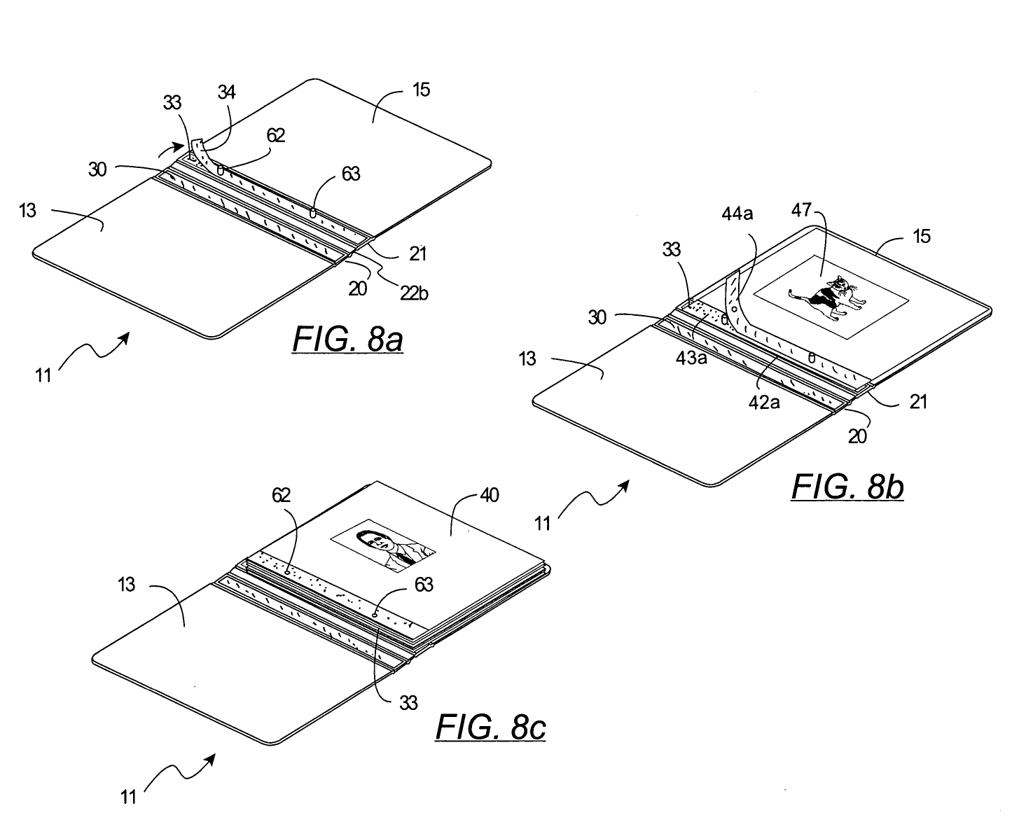

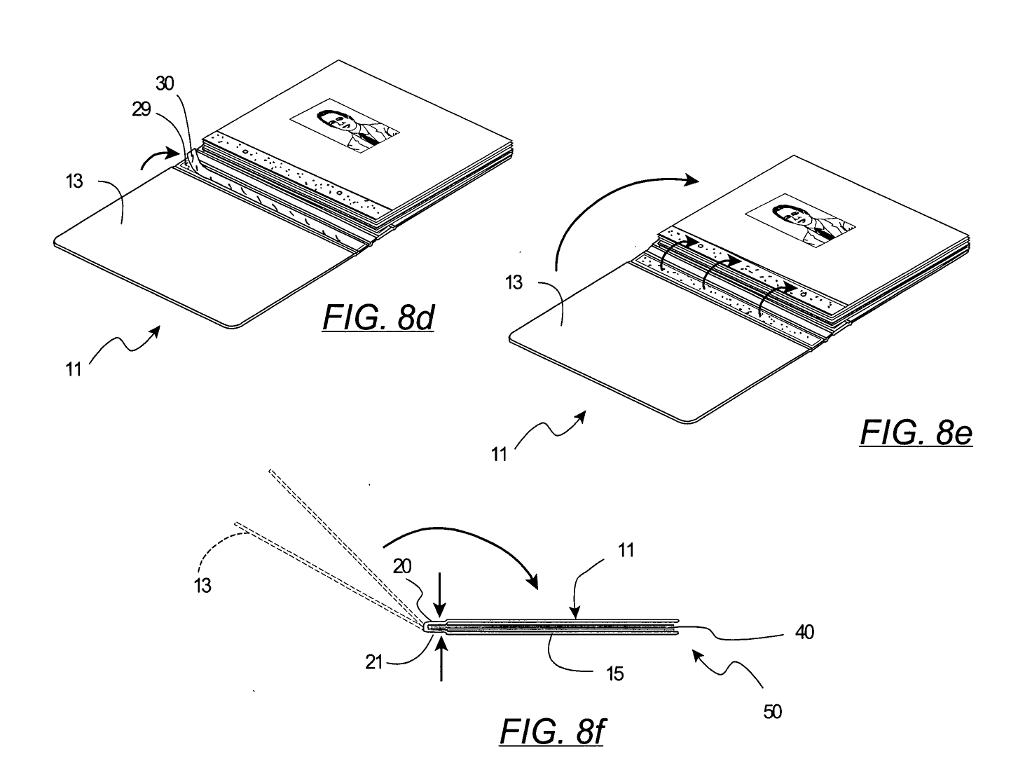

FIGS. 8a-f illustrate the steps in the assembly of the perfect bound book in accordance with the principles of the invention. The illustrated steps are meant to be only a typical method of assembly, it being understood that any desired sequence of steps can be used to create the final product. Prior to assembly, images (represented as example images 47) are printed on at least a portion of the plurality of sheets of paper 12. The term “images,” as used herein, refers to collectively to text matter, graphics, photographs, and any other miscellaneous indicia which can be printed or otherwise rendered in “hard copy” form. This can be accomplished with a printer coupled to a personal computer, or a color copier, a digital printing press or any other suitable means to transfer the desired images to the paper 12. Images 47 can be printed on one or both sides of the sheets of paper 12. In addition, the pages of the book can contain hand-rendered material, such as original artwork in any suitable medium. The pages can also include hand-assembled media, such as collages.

As shown in FIG. 8a, the removable strip 34 is removed from adhesive region 33 on the spine panel 21. A sheet of paper 40a is then is then adhered to the adhesive region 33, with the alignment pegs 62 and 63 inserted through apertures 162,163 in the paper as shown in FIG. 8b. The strip 44a can be removed from a sheet of paper 40a to expose the adhesive region 43a. Subsequent sheets are adhered in this manner in stacked configuration over alignment pegs 62 and 63 as shown in FIG. 8c. (If the attachment pegs 62 and 63 are not used, the kit of the invention can further include an alignment aid, such as a right angle shaped implement, to enable the user to correctly align the pages.)

In FIG. 8d, the adhesive strip 44 (not shown) is removed to expose adhesive region 43 on the paper 40. The removable strip 34 is peeled away to expose the adhesive region 33 on the spine panel 20. The sheets of paper are then affixed to the cover 11 by applying sufficient pressure to engage the adhesive region 33 with the adhesive region 44 on the paper. As shown in FIG. 8f, the front cover panel 13 can then be folded inward along flexible web 22b to be in alignment with rear cover panel 15 and coextensive with the sheet of paper 40. Pressure can then be applied to the spine panels 20, 21 to engage the adhesive region. The product thus formed is the perfect bound book 50. The spine panels are thereby placed in a fixed position so that said cover panels are available to open along the interstitial spaces 19a and 19c.

If desired, the kit 10 can also include decorative facing sheets which can be inserted between the cover 11 and the booklet 38. This example illustrates the images 47 being printed on the side of the sheets of paper 40 containing the adhesive region 43, however it will be understood that images could also be printed on the opposite side, with the booklet 38 being assembled using steps in reverse of the illustrated steps (i.e. from front to back, instead of from back to front as shown.) The score lines 45 in the individual sheets of paper 40 serve to facilitate the turning of the pages in the booklet 38.

The invention also contemplates having selectably removable alignment structures which remain in place only during the assembly process and are discarded just prior to sealing the cover 11 of the book. In this embodiment, attachment pegs 62 and 63 can be applied to one of the spine panels 20,21 during the assembly process using a weak adhesive which allows the pegs 62 and 63 to be removed after the plurality of pages are properly aligned. In one arrangement, one of the spine panels 20,21 includes holes therein sized to receive the alignment pegs in a closely engaged arrangement. The alignment pegs 62 and 63 can also be fixedly attached to the spine panel and each include a frangible seam which allows the alignment pegs 62, 63 to be can be detached from the spine panel by breaking the alignment pegs at the frangible seam.

The cover 11 can a decorative covering, such as cloth, leather, faux leather, etc. In an alternative embodiment of the kit of the invention, the cover 11 can be unfinished for the purpose of allowing custom-finishing by the consumer. For example, fabric or paper can be glued directly onto the cover 11. The kit can also include paper cover sheet adapted to partially wrap around the cover 11.

The front cover panel 13 can include a recess 49 which can receive a label (not shown). The recess 49 can have any desired shape or position on the front cover. The kit of the invention can include printable labels, such as adhesive-backed labels, which can inserted into the recess 49. The recess 49 preferably has a depth approximately equal to that of the label so that the label will be flushly aligned with the surface.

The invention contemplates the printing of images from digital files to create the pages of a perfect bound book, however any subject matter can be printed on the sheets of paper 12, such as text matter, graphic artwork, etc. It will be appreciated that a user can utilize the invention in combination with a personal computer, printer and software to create a custom perfect bound book from any type of printed matter. The kit and method of the invention are especially well suited for the creation of a custom photograph album in the form of a perfect bound book.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

1. A kit for constructing a perfect bound book, comprising:
a book-like cover having an inside surface and an outside surface comprising first and second rigid cover panels each having a length, a width and front and rear surfaces and first and second rigid spine panels each having a length, a width and front and rear surfaces with said length of said spine panels being equal to that of said front and rear rigid cover panels and said width being substantially less that than that of said front and rear cover panels, said panels juxtaposed along said lengths with interstitial spaces therebetween with said spine panels interposed between said first and second rigid cover panels, said front and rear surfaces of said panels coextensively adhered to a least one sheet flexible material with said flexible material providing flexible webbing in said interstitial spaces and said fabric forming the inside surface and outside surface of said cover;
said inside surface of said cover including first and second adhesive regions respectively positioned on said first and second spine panels;
a plurality of sheets of paper sized to fit within said book-like cover, each of said sheets of paper having a binding edge and an adhesive region adjacent to said binding edge;
whereby said plurality of sheets of paper can be adhered to one another in a substantially coextensive configuration by said adjoining said adhesive regions at said binding edge and then adhered to said cover by said first and second adhesive regions on said spine to form a perfect bound book wherein said spine panels are thereby placed in a fixed position and said cover panels are available to open along said interstitial spaces.

2. The kit of claim 1, wherein said cover further comprises an alignment structure attached to and protruding from one of said spine panels, and said plurality of sheets of paper each include at least one aperture therein sized to receive said alignment structure in a closely engaged arrangement, and said alignment structure is positioned to properly align said paper within said cover.

3. The kit of claim 2, wherein said at least one aperture in said paper is positioned in said adhesive region thereof.

4. The kit of claim 2, wherein said alignment structure comprises at least two cylindrical alignment pegs longitudinally aligned in said spine panel and extending perpendicularly therefrom, and said plurality of sheets of paper each include at least two apertures positioned in said adhesive region to align with said at least two alignment pegs.

5. The kit of claim 4, wherein said at least two alignment pegs are selectably removable from said spine panel.

6. The kit of claim 5, wherein one of said spine panels includes holes therein sized to receive said at least two alignment pegs in a closely engaged arrangement.

7. The kit of claim 4, wherein said at least two alignment pegs are fixedly attached to said spine panel.

8. The kit of claim 7, wherein each of said at least two alignment pegs each include a frangible seam therein whereby said alignment pegs can be detached from said spine panel by breaking said alignment pegs at said frangible seam.

9. The kit of claim 4, wherein said interstitial space between said spine panels has a width, and said alignment pegs have a height approximately equal to said width of said interstitial space.

10. The kit of claim 1, wherein said first and second adhesive regions on said spine panel are comprised of double-sided tape having a removable strip thereon.

11. The kit of claim 4, wherein said first and second adhesive regions on said spine panels are each comprised of an double-sided tape respectively having first and second removable strips thereon, and one of said removable strips includes apertures therein corresponding to said at least two alignment pegs whereby said alignment pegs extend through said removable strip.

12. The kit of claim 1, wherein said first and second adhesive regions on said spine panels are comprised of an adhesive coating layer having a removable strip thereon.

13. The kit of claim 4, wherein said first and second adhesive regions on said spine panels are each comprised of an adhesive coating layer respectively having a fist and second removable strips thereon, and one of said removable strips includes apertures therein corresponding to said at least two alignment pegs whereby said alignment pegs extend through said removable strip.

14. The kit of claim 1, wherein said adhesive region adjacent to said binding edge of each of said plurality of sheets of paper is comprised of an adhesive coating layer covered with a removable strip.

15. The kit of claim 1, wherein said adhesive region adjacent to said binding edge of each said plurality of sheets of paper is comprised of double-sided tape covered with a removable strip.

16. The kit of claim 1, wherein each of said plurality of sheets of paper includes a score line adjacent to said adhesive region.

17. The kit of claim 1, further including a paper cover sheet adapted to partially wrap around said book-like cover, wherein said paper cover sheet has a width equal to the length of said spine.

18. The kit of claim 1, wherein said paper is photographic paper.

19. The kit of claim 1, wherein said paper is ink jet paper.

20. The kit of claim 1, wherein flexible material comprises first sheet of said flexible material covering said outer surface and a second sheet of flexible material covering said inner surface.

21. The kit of claim 19, wherein at least one of said first and second sheets of flexible material is fabric.

22. The kit of claim 19, wherein at least one of said first and second sheets of flexible material is leather.

23. The kit of claim 19, wherein at least one of said first and second sheets of flexible material is a petroleum-based synthetic sheeting material.
